(19) United States
(12) Patent Application Publication
(10) Pub. No.: US 2006/0251099 A1
(43) Pub. Date: Nov. 9, 2006

(54) Method for transmitting/receiving broadcasting data frames in mobile communication system supporting boradcasting service

(76) Inventors: Soeong-Hun Kim, Gyeonggi-do (KR); Kook-Heui Lee, Gyeonggi-do (KR); Kyeong-In Jeong, Gyeonggi-do (KR); Sung-Oh Hwang, Gyeonggi-do (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/566,500

(22) PCT Filed: Aug. 12, 2004
(86) PCT No.: PCT/KR04/02028

§ 371 Date: Jan. 31, 2006

(30) Foreign Application Priority Data
Aug. 12, 2003 (KR) 10-2003-0055892

(51) Int. Cl. H04J 3/26

(52) U.S. Cl. 370/432

(57) ABSTRACT

Logical channels including a broadcasting service transmission channel and a broadcasting service control channel are transmitted to or received by UEs in each cell by a transport channel. The broadcasting service transmission channel carries broadcasting data, and the broadcasting service control channel carries control information for the broadcasting service. In the transmission/reception, a network controller and the UEs share logical channel multiplexing options for transmission of the transport channel, and MAC PDUs having header information different according to the logical channel multiplexing options are transmitted

### BACKGROUND OF THE INVENTION

1. Field of the Invention

The present invention relates to a method for transmitting/receiving broadcasting data according to a broadcasting service in a mobile communication system, and more particularly to a method for setting header information of a frame transmitting broadcasting data.

2. Description of the Related Art

With the recent development of a communication industry, a voice data service has been changed to a packet service (i.e., service for multicasting multimedia communication) transmitting a large quantity of data such as packet data and circuit data. In order to support the multicasting multimedia communication, a broadcast/multicast service has been discussed, which provides a service from one or multiple multimedia data sources to multiple user equipments (‘UE’). The broadcast/multicast service may be classified as a cell broadcast service (‘CBS service’), which is a message-centered service, and a multimedia broadcast/multicast service (‘MBMS service’) supporting a multimedia such as real-time image and voice, still image, character, etc.

The CBS service is a service broadcasting a plurality of messages to all UEs located in a specific service area. Herein, the specific service area providing the CBS service may be an entire area to which the CBS service is provided in one cell.

The MBMS service is a service supporting a multimedia such as real-time image and voice, still image, character, etc., and requires a large quantity of transmission resources. Accordingly, in view of the possibility that multiple services may be simultaneously provided in one cell, the MBMS service is provided through a broadcasting channel. In particular, the MBMS service requires much more radio resources in comparison with the CBS service. Further, the MBMS service may be provided by one of point-to-point (‘PtP’) mode and point-to-multipoint (‘PtM’) mode in consideration of the number of UEs intended for reception of the MBMS service or transmission power consumed by the MBMS service. In the PtP mode, a dedicated channel is assigned to each UE and a desired MBMS service is provided to the UE when the number of UEs intended for reception of the MBMS service is small in a cell or surplus transmission power is sufficient. In contrast, in the PtM mode, a common channel is assigned to UEs and a desired MBMS service is provided to the UEs when the number of UEs intended for reception of the MBMS service is large in a cell or surplus transmission power is not sufficient. It is possible that an MBMS service having been provided in a PtP mode according to each cell is provided in a PtM mode to which the PtP mode has been switched. In contrast, it is possible that an MBMS service having been provided in a PtM mode is provided in a PtP mode to which the PtM mode has been switched. However, the switching of a mode is limited to a case in which environments providing an MBMS service change.

FIG. 1 is a block diagram showing the structure of a UMTS terrestrial radio access network (‘UTRAN’) in the conventional asynchronous mobile communication network supporting an MBMS service.

Referring to FIG. 1, the UTRAN includes a plurality of radio network systems (‘RNSs’) 110 and 120. The RNSs 110 and 120 includes radio network controllers (‘RNCs’) 111 and 112, multiple base transceiver stations 115, 113, 114 and 116 (‘node Bs’) controlled by the RNCs 111 and 112, and a plurality of cells belonging to the node Bs 115, 113, 114 and 116. The RNCs 111 and 112 control the node Bs 115, 113, 114 and 116 and provide an MBMS service to one of the node Bs 115, 113, 114 and 116 in which a UE requesting the MBMS service exists. Further, the RNCs 111 and 112 control radio channels set for providing the MBMS service and create and manage service contexts regarding an MBMS service provided by the RNCs 111 and 112. Therefore, the RNCs 111 and 112 manage radio resources assigned to UEs in a RRC connected mode state and manage the mobility of the UEs. Additionally, the RNCs 111 and 112 manage a RRC connection of UEs located in areas of the node Bs 115, 113, 114 and 116 controlled by the RNCs 111 and 112. Also, the RNCs 111 and 112 play a role of sending signals, which must be transmitted to the UEs, from a core network (‘CN’) to corresponding UEs. Herein, the total number of node Bs controlled by each of the RNCs 111 and 112 and the total number of cells belonging to each node B may be determined by a carrier. The node Bs 115, 113, 114 and 116 play a role of providing actually assigned radio resources. The radio resources are formed according to each cell and the radio resources provided by the node Bs 115, 113, 114 and 116 are radio resources of cells controlled by the node Bs 115, 113, 114 and 116. As shown in FIG. 1, the UE may form a radio channel by using radio resources provided by a cell of a specific node B and perform communication through the formed radio channel. Since the UE recognizes only a physical layer formed according to each cell, it is meaningless to distinguish the node B from a cell. Accordingly, the node B is used together with the cell in a description which will be described later.

A CN 100 and each of the RNCs 111 and 112 are connected to each other through a lu interface, each of the RNCs 111 and 112 and each of the node Bs 115, 113, 114 and 116 are connected to each other through a lub interface, and the RNCs 111 and 112 are connected to each other through a lur interface. Further, there exists a Uu interface between a UE and a UTRAN.

The lu interface, the lub interface, and the Uu interface, etc., may be regarded as a protocol stack formed for communication between nodes. For instance, the Uu interface includes a control plane of RRC/radio link control (‘RLC’)/medium access control (‘MAC’)/PHY and a user plane of packet data convergence protocol (‘PDCP’)/RLC/MAC/PHY.

FIG. 2 is a view showing in detail the structure of the conventional Uu interface. The Uu interface includes a control plane (C-plane) and a user plane (U-plane). The control plane performs a function of exchanging a control signal between a UE and a RNC and the user plane performs a function of transmitting user data between the UE and the RNC. The control plane includes a RRC layer, a RLC layer, a MAC layer and a physical layer and the user includes a PDCP layer, a broadcast multicast control (‘BMC’) layer, a RLC layer, a MAC layer, a physical layer, etc.

The physical layer is a layer providing a information transmission service using a radio transmission technology and corresponds to a first layer of an open system interconnection (OSI) layer. The physical layer is connected to the MAC layer through a transport channel and data exchange between the MAC layer and the physical layer is performed through the transport channel. The transport channel is defined by a scheme through which specific data are processed in the physical layer.

The MAC layer plays a role of sending data transmitted from a RLC layer through a logical channel to the physical layer through a proper transport channel and sending data transmitted from the physical layer through a transport channel to the RLC layer through a proper logical channel. Further, the MAC layer inserts additional information into data received through the logical channel or the transport channel, analyzes the inserted additional information to perform a proper operation and controls a random access operation.

The MAC layer and the RLC layer are connected to each other through a logical channel. The MAC layer includes several sub-layers and the sub-layer contains a MAC-b, MAC-d, MAC-d/sh, etc. The sub-layer will be described in detail later during the description of a logical channel.

The RLC layer takes charge of the setting and release of a logical channel and may operate in one of an acknowledged mode (AM) operation mode, an unacknowledged mode (UM) operation mode and a transparent mode (TM) operation mode. Herein, there exist difference in functions provided in the operation modes. Generally, the RLC layer divides service data unit (SDU) sent from an upper layer at a proper size and vice versa. Further, the RLC layer takes charge of an error correction function through an automatic retransmission request (ARQ).

The PDCP layer is disposed above the RLC layer and performs a header compression function of data transmitted in an IP packet form and a function of transmitting data without loss even when a RNC providing a service changes due to the movement of a UE. The BMC layer also is disposed above the RLC layer and supports a broadcasting service of transmitting same data to unspecified multiple UEs located in a specific cell. The RRC layer takes charge of the assignment or release of radio resources between a UTRAN and a UE.

As described above, a discussion on the MBMS service of transmitting same data to multiple UEs through one radio channel has been currently developed by a 3GPP. Above all, the MBMS service can reduce radio resources by providing a service to multiple UEs located in the same cell by means of one radio channel, in comparison with the conventional scheme assigning a dedicated radio channel to each UE. In order to provide the MBMS service, some alternation is required in the protocol stack of the conventional Uu interface. In particular, a RRC layer must have a function of processing a MBMS control message. Further, the Uu interface must further include a new MAC-m layer for controlling a corresponding relation between a MBMS traffic channel (‘MTCH’) and a transport channel. The MAC-m layer may be added to a MAC-c/sh layer which is a sub-layer of a MAC layer.

The aforementioned logical channel will be described in detail hereinafter.

The logical channel is a channel through which data having specific properties. In particular, the logical channel is constructed by a combination of a RLC layer and a MAC layer which are suitable for processing the data having the specific properties. The logical channel is generated in a call set-up process and then eliminated in the release of a call. For instance, a random logical channel may be generated for transmitting voice data in a call set-up process for voice communication. Herein, the generation of the logical channel signifies that one RLC entity suitable for processing voice data is generated (an RLC TM entity is generated because it is voice communication) and the RLC entity is connected to a MAC layer. Accordingly, transmission/reception of data through a random logical channel represents the processing of data through a specific RLC entity and MAC entity.

Logical channels currently defined by a standard are limited as follows according to an RLC operation mode, a MAC entity type and a transport channel corresponding to the kinds of the logical channels.

A broadcast control channel (‘BCCH’) is a logical channel through which system information is transmitted, and it is transmitted through a RLC TM and a MAC-b. The BCCH is transmitted through a transport channel including a broadcast channel (‘BCH’) or a forward access channel (‘FACH’).

A common control channel (‘CCCH’) is a logical channel through which the initial registration message, etc., of a UE is transmitted. In a case of forward transmission, the CCCH is transmitted through a RLC UM and a MAC-c/sh. In a case of backward transmission, the CCCH is transmitted through a RLC TM and a MAC-c/sh. The CCCH is transmitted through a FACH in forward transmission and transmitted through a random access channel (‘RACH’) in backward transmission.

A dedicated control channel (‘DCCH’) is a logical channel through which a RRC message relating to a specific UE is transmitted, and it is transmitted through a RLC UM and a RLC AM. When a transport channel transmitting the DCCH is a dedicated channel (‘DCH’), a MAC layer is constructed by a MAC-d. In contrast, when a transport channel transmitting the DCCH is a common channel such as a RACH or FACH, a MAC layer is constructed by a MAC-d and a MAC-c/sh.

Besides these channels, logic channels such as a dedicated traffic channel (‘DTCH’), a common traffic channel (‘CTCH’), a paging control channel (‘PCCH’), etc., are defined.

The MAC-b and MAC-d will be briefly described hereinafter.

The MAC-b plays a role of transmitting a BCCH, which a logical channel transmitting system information, to a BCH, and one MAC-b is constructed for each cell. The MAC-d is a MAC entity connected to a DTCH or a DCCH and one MAC-d is constructed for each UE. Multiple DTCHs or DCCHs may be assigned to one ULE and the MAC-d plays a role of inserting an identity distinguishing multiple logical channels from each other. A MAC-c/sh is a sub-layer of a MAC layer used when a DTCH, a DCCH, a CCCH, a BCCH, a CTCH or a PCCH is transmitted/received through a FACH, a RACH, a PCH, or a DSCH which is a common transport channel. A detailed description on the MAC-c/sh will be given with reference to FIG. 3 later.

The MTCH and the MCCH among the aforementioned logical channels are logical channels newly introduced to provide an MBMS service.

The MTCH is a logical channel transmitting data of a specific MBMS service. Accordingly, the MTCH may be constructed by the number of MBMS services provided in a cell. However, a UE recognizes and receives only a MTCH relating to an MBMS service received by the UE. The MTCH is transmitted through a RLC UM and a MAC-c/sh/m. The MAC-c/sh/m is a sub-layer of a MAC layer changed so that a MAC-c/sh can process a MTCH and a MCCH.

The MCCH is a logical channel through which a control message relating to an MBMS service is transmitted. Further, one MCCH is constructed for each cell and the MCCH is transmitted through a RLC UM and a MAC-c/sh/m. The MTCH and the MCCH are transmitted through a FACH.

Next, a transport channel will be briefly described hereinafter. The transport channel is defined by the kind of the transport channel and a transport format set (TFS) representing methods by which specific data are processed in a physical layer.

A dedicated channel (‘DCH’) is a transport channel transmitting a DCCH and a DTCH. The DCH is transmitted to only a specific UE and a transmission power control is performed. Further, a forward DCH and a backward DCH exist.

A FACH is a transport channel transmitting various kinds of logical channels such as BCCHs, CCCHs, CTCHs, DCCHs, DTCHs, etc. The FACH must be received in all UEs and only a forward FACH exists.

Besides the DCH and the FACH, there exist various transport channels such as paging channels (PCHs), downlink shared channels (DSCHs), uplink shared channels (USCHs), common packet channels (CPCHs), etc.

The aforementioned transport channels are defined by a TFS defined according to each transport channel as well as a basic character defined according to the aforementioned kind of the transport channels. The TFS is assigned according to each transport channel and a plurality of transport formats (TFs) exist in one TFS. Each TF is identified by a transport format identity and the TF includes a semi-static part and a dynamic part.

The semi-static part is a parameter applied to all TFs of a specific transport channel and parameter representing a transmission time interval (TTI) for which data of the transport channel are transmitted/received, a channel coding and a coding rate to be applied to data of a corresponding transport channel, and the size of a CRC to be applied to data of a corresponding transport channel.

The dynamic part is a parameter applied according to the specific transport format of a specific transport channel and includes parameters such as the amount (transport block set size) of data transmitted/received per a unit time.

The aforementioned multiple transport channels may be transmitted through one physical channel. Accordingly, when multiplexing the multiple transport channels to one physical channel, a transport format combination identity (‘TFCI’) is also multiplexed, so that TFs according to each transport channel are notified to a reception side. A combination of TFCIs about the transport channels transmitted through one physical channel will be a transport format combination set (‘TFCS’).

FIG. 3 is a view showing the structure of the conventional MAC-c/sh constituting a RNC. A method by the MAC-c/sh process a FACH will be described with reference to FIG. 3.

The MAC-c/sh is one of sub-layers, which constitutes a MAC layer, processing common transport channels formed in one cell to transmit the common transport channels to an upper layer through a proper logical channel, or processing logical channels from an upper layer to transmit the logical channels to a proper common transport channel.

FIG. 3 shows a PCH, a FACH, a DSCH, a USCH, a RACH, a CPCH, etc., contained in the common transport channel. Only a process by which the FACH 340 of the common transport channels shown in FIG. 3 is processed will be described hereinafter.

The logical channel multiplexed to the FACH 340 by the MAC-c/sh includes a BCCH (305), a CCCH (310), a CTCH (315), a DCCH, a DTCH, etc. The DCCH and the DTCH is sent to the MAC-c/sh through a MAC-d (320).

Data transmitted through the logical channels are sent to a function block, which is a TCTF MUX/UE id MUX (325) constituting the MAC-c/sh. The TCTF MUX/UE id MUX (325) is divided into a TCTF MUX and a UE id MUX. A TCTF value representing the kind of corresponding logical channels is inserted into data transmitted through the logical channel by the TCTF MUX. An identity of a UE receiving data is inserted into data transmitted through the logical channel by the UE id MUX. For reference, the function block is a general term representing an apparatus performing a specific role such as TCTF insertion, a UE id insertion, etc.

The data passing through the TCTF MUX/UE id MUX 325 are transmitted to a scheduling/priority handling/demux 330 which is a function block. The scheduling/priority handling/demux 330 schedules the data transmitted through each logical channel according to the priority of the logical channel.

The data passing through the scheduling/priority handling/demux 330 are transmitted to a TFC selction 335 which is a function block. The TFC selction 335 selects a proper TFC when multiple transport channels correspond to one logical channel. The data passing through the TFC selction 335 are finally transmitted through a FACH 340.

As described above, the data to be transmitted through the FACH 340 are processed while always passing trough the TCTF MUX/UE id MUX 325, the scheduling/priority handling/demux 330, and the TFC selction 335 which are function blocks.

Meanwhile, since the MTCH and the MCCH newly introduced for an MBMS service must be transmitted to all UEs in a cell, it is preferred to be transmitted through the FACH. Therefore, the MAC-c/sh/m, which is a sub-layer, is added to the MAC-c/sh. The MAC-c/sh/m is a sub-layer having a function of processing the MTCH and the MCCH in the MAC-c/sh. That is, the MAC-c/sh/m is a sub-layer having a function of transmitting the MTCH and the MCCH to the FACH as well as the existing function of the MAC-c/sh. The structure of the MAC-c/sh/m is shown in FIG. 4. For convenience of description, FIG. 4 does not show the MAC-c/sh. However, the MAC-c/sh/m is actually obtained by adding the MAC-c/sh shown in FIG. 3 to FIG. 4.

FIG. 4 is a view showing the structure of the conventional MAC-c/sh/m formed in a RNC. One MAC-c/sh/m is constructed for each cell. The MAC-c/sh/m plays a role of processing data transmitted through the MCCH and the MTCH formed in each cell and causing the processed data to correspond to a proper FACH. One MCCH and multiple MTCHs may be formed in one cell. For convenience of description, it is assumed that two MTCHs are formed in FIG. 4.

Roles of multiple function blocks constituting the MAC-c/sh/m will be described with reference to FIG. 4.

When the multiple MTCHs are transmitted through one FACH, an add MBMS ID 425 is a function block inserting a MBMS identity enabling MBMS services transmitted according to each MTCH to be distinguished from each other. When various kinds of logical channels are transmitted through one FACH, a TCTF MUX 430 is a function block inserting target channel type field (TCTF) values representing the kinds of the logical channels. The logical channel may include a BCCH, a CCCH, a DCCH, a DTCH, etc. Meanwhile, the TCTF values corresponding to the kinds of the logical channels have been already defined. A scheduling/priority handling 435 is a function block scheduling each logical channel according to the priority of the logical channels. When multiple FACHs are transmitted through one logical channel, a TFC selection 440 is a function block selecting a proper TFC.

Among the function blocks, the add MBMS ID 425 and the TCTF MUX 430 each add a MAC header to a MAC service data unit (SDU).

FIG. 5 shows the structure of a MAC PDU 520 of data to be transmitted through a MTCH when the structure of the MAC-c/sh/m shown in FIG. 4 is used. For reference, in the data to be transmitted through the MTCH, a SDU and a PDU are general terms indicating data between layers on a protocol stack. The SDU represents data transmitted to a specific layer and the PDU represents data processed in a specific layer. For instance, a MAC SDU represents data transmitted from an upper layer to a MAC layer and a MAC PDU represents data transmitted to a lower layer after having been processed a MAC layer.

As shown in FIG. 5, MBMS data transmitted/received through the MTCH includes a MAC header portion containing a TCTF field 505 and a MBMS ID field 510 and a payload portion containing a MAC SDU 515. The MAC SDU 515 represents data transmitted to the MAC-c/sh/m through the MTCH. Herein, a MBMS ID is added to the MAC SDU 515 by the add MBMS ID 425. The MBMS ID is an identity of a MBSM service relating to a MTCH to which a MAC SDU belongs. The MAC SDU to which the MBMS ID has been added is combined with a TCTF 505 by the TCTF MUX 430. The TCTF 505 is a field representing the fact that the MAC SDU 515 belongs to the MTCH. The TCTF is a value basically representing the kinds of logical channels and the TCTF values have been already determined according to a BCCH, a CCCH, a CTCH, a DCCH and a DTCH. For instance, the TCTF value assigned to the BCCH is 00. Since the MCCH and the MTCCH are newly defined logical channels, it is expected that new TCTF values are assigned to the MCCH and the MTCH.

In brief, TCTF field 505 of the MAC PDU 520 containing the MBMS data indicates that the MAC PDU 520 is MBMS data and the MBMS ID field 510 indicates an the MBMS service relating to the MAC PDU 520. When the MAC SDU 515 is transmitted to the MAC-c/sh/m through a newly defined MTCH 415 or 420, the MAC SDU 515 is processed in each function block constituting the MAC-c/sh/m. Also, when the MAC SDU 515 is transmitted through a FACH 445 or 450, the MAC SDU 515 has the same structure as that of the MAC PDU 520 as shown in FIG. 5.

The MAC PDU 520 is transmitted to the MAC-c/sh/m of a UE through a physical layer. The MAC-c/sh/m of the UE performs necessary processes for the MAC PDU 520 and transmits the MAC SDU to an upper layer through a MTCH.

FIG. 6 shows the structure of the conventional MAC-c/sh/m of a UE.

Conventionally, a UE has one MAC-c/sh/m. The MAC-c/sh/m receives a FACH transmitted from a cell in which a corresponding UE is located and plays a role of transmitting a MTCH through which data of a desired MBMS service are transmitted and a MCCH provided in a corresponding cell to an upper layer. When the UE receives a plurality of MBMS services, the UE may have a plurality of MTCHs. Further, when multiple FACHs are formed in one cell, the UE may receive the FACHs.

Referring to FIG. 6, data (i.e., MAC PDUs) having been received through FACHs 630 and 635 are transmitted to the TCTF DEMUX 625 of a MAC-c/sh/m. The TCTF DEMUX 625 is a function block of analyzing TCTF values of the received MAC PDUs and transmitting the MAC PDUs to a proper function block. For instance, as a result of the analysis of the TCTF values, when the received data correspond to a MCCH, the TCTF DEMUX 625 transmits the data to an upper layer connected to the MCCH. In contrast, when the received data correspond to a MTCH, the TCTF DEMUX 625 transmits the data to a read MBMS ID 620. The read MBMS ID 620 is a function block of inspecting the MBMS ID of the received MAC PDU and discarding the MAC PDU or transmitting the MAC PDU to an upper layer. Herein, when the MBMS ID of the received MAC PDU coincides With the MBMS ID of an MBMS service which a UE is to receive, the read MBMS ID 620 transmits the received MAC PDU to an upper layer through a corresponding MTCH. In contrast, when the MBMS ID of the received MAC PDU does not coincide with the MBMS ID of the MBMS service which the UE is to receive, the read MBMS ID 620 discards the received MAC PDU. One MTCH 610 corresponds to the MBMS service which the UE is to receive and One MTCH 615 corresponds to the MBMS service which the UE is to receive. The MTCHs 610 and 615 connect a RLC layer to a MAC-c/sh/m.

As described above, the MBMS data are transmitted through the MTCH which is a new logical channel and the MTCH is transmitted through the FACH. Further, the TCTF field is disposed at the front portion of the MAC PDU transmitted through the conventional FACH, thereby indicating a logical channel to which the corresponding MAC PDU belongs and a function block to which the corresponding MAC PDU is transmitted. This is because various kinds of logical channels (BCCH, CCCH, CTCH, DCCH and DTCH) are multiplexed as described in the conventional FACH. Accordingly, since function blocks which must be transmitted according to each logical channel are different from each other, it is necessary to indicate a logical channel to which a certain MAC PDU belongs through the TCTF field. Meanwhile, the FACH transmitting the MTCH may be different from the conventional FACH. In the case of the conventional FACH, the configuration information of the FACH such as logical channel information and transport channel information is known from system information. The FACH, of which configuration information is known from the system information, is a transport channel received by all UEs regardless of the reception of the MBMS service. Accordingly, the MBMS service is provided through the FACH of which configuration information is known from the system information, thereby causing the problem in that even UEs which does not receive the MBMS service must receive the FACH. However, such a problem can be solved by employing a new FACH, configuration information of which can be understood from the MCCH received by only UEs intended for reception of the MBMS service, instead of the conventional FACH.

In this way, when the MTCH is transmitted through the new FACH of which configuration information is known from the MCCH, multiplexing options different from the conventional FACH may exist.

The conventional FACH is a FACH of which configuration information is known to all UEs through the system information and the new FACH is a FACH of which configuration information is known to only UEs intended for reception of the MTCH. The new FACH may be formed in a physical channel different from the conventional FACH and may have a TFS different from the conventional FACH.

<Logical Channel Multiplexing Option of the Conventional FACH>

1. Various logical channels, such as BCCHs, CCCHs, CTCHs, DCCHs, DTCHs, MCCHs, MTCHs, are multiplexed through the FACH.

<Logical Channel Multiplexing Option of The New FACH>

1. Various logical channels, such as BCCHs, CCCHs, CTCHs, DCCHs, DTCHs, MCCHs, MTCHs, are multiplexed through the FACH.

2. Only one kind of MTCH is multiplexed through the FACH. Herein, multiple MTCHs are multiplexed.

3. Only one kind of MTCH is multiplexed through the FACH. Herein, only one MTCH is multiplexed.

The structure of the MAC PDU proposed in FIG. 5 is efficient in supporting the logical channel multiplexing option of the conventional FACH and the first logical channel multiplexing option of the new FACH. However, the structure of the MAC PDU proposed in FIG. 5 is inefficient in supporting the second and the third logical channel multiplexing option of the new FACH.

For instance, in the case of the third logical channel multiplexing option of the new FACH, since only one MTCH exists in one FACH, the TCTF field and the MBMS ID field are not necessary. Also, in the case of the second logical channel multiplexing option of the new FACH, since other kinds of logical channels do not exist in one FACH, the TCTF field is not necessary.

### SUMMARY OF THE INVENTION

Therefore, the present invention has been made in view of the above-mentioned problems, and it is an object of the present invention to provide a method for transmitting at least one MTCH, which is a logical channel, through a FACH.

It is another object of the present invention to provide a method in which a RNC determines the MAC header format of a MTCH, through which MBMS data are transmitted, according to the multiplexing situation of a transport channel, transmits the determined MAC header format to UEs, and uses a MAC header which is the most suitable for a given situation.

It is further another object of the present invention to provide a method for applying the MAC header format of a MTCH according to a variety of circumstances.

According to an aspect of the present invention, there is provided a method for generating a frame transmitting broadcasting data in a radio network controller of a mobile communication system transmitting logical channels, which include a broadcasting service transport channel transmitting the broadcasting data according to a broadcasting service and a broadcasting service control channel transmitting control information according to the broadcasting service, to one or more user equipments located in each cell through a transport channel, the method comprising the steps of: determining at least one logical channel to be transmitted through one transport channel; and generating a frame which does not contain a target channel type field (TCTF) and a MBMS ID field, but contains a payload for transmitting the broadcasting data, when one broadcasting service transport channel is determined as the logical channel.

Preferably, the method further includes a step of generating a frame containing the MBMS ID field and the payload for transmitting the broadcasting data, when multiple broadcasting service transport channels are determined as the logical channel.

Preferably, the method further includes a step of generating a frame containing the target channel type field, the MBMS ID field, and the payload for transmitting the broadcasting data, when one or more broadcasting service transport channels and other logical channels are determined as the logical channel.

Preferably, the method further includes a step of, before transmitting the frame, transmitting a target channel type field identity and a MBMS ID identity, which represents whether or not the target channel type field and the MBMS ID field are contained in the frame, to the user equipment through the broadcasting service control channel.

According to an aspect of the present invention, there is provided a method for receiving a frame including broadcasting data from a radio network controller in a user equipment of a mobile communication system receiving logical channels, which include a broadcasting service transport channel transmitting the broadcasting data according to a broadcasting service and a broadcasting service control channel transmitting control information according to the broadcasting service, through a transport channel, the method comprising the steps of: confirming a logical channel multiplexing option used in the frame through the broadcasting service control channel; setting a processing path of the frame by the logical channel multiplexing option; and processing the frame through the set processing path.

Preferably, when it is confirmed that the logical channel multiplexing option is a logical channel multiplexing option transmitting only one broadcasting service transport channel through one transport channel, a function block for processing a target channel type field and a MBMS ID field is excluded from the processing path.

Preferably, when it is confirmed that the logical channel multiplexing option is a logical channel multiplexing option transmitting multiple broadcasting service transport channels through one transport channel, a function block for processing a MBMS ID field constituting the message is contained in the processing path.

Preferably, when it is confirmed that the logical channel multiplexing option is a logical channel multiplexing option transmitting at least one broadcasting service transport channel and other logical channels through one transport channel, a function block for processing a target channel type field and a MBMS ID field constituting the message is contained in the processing path.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a block diagram showing the structure of a UTRAN in the conventional asynchronous mobile communication network supporting an MBMS service;

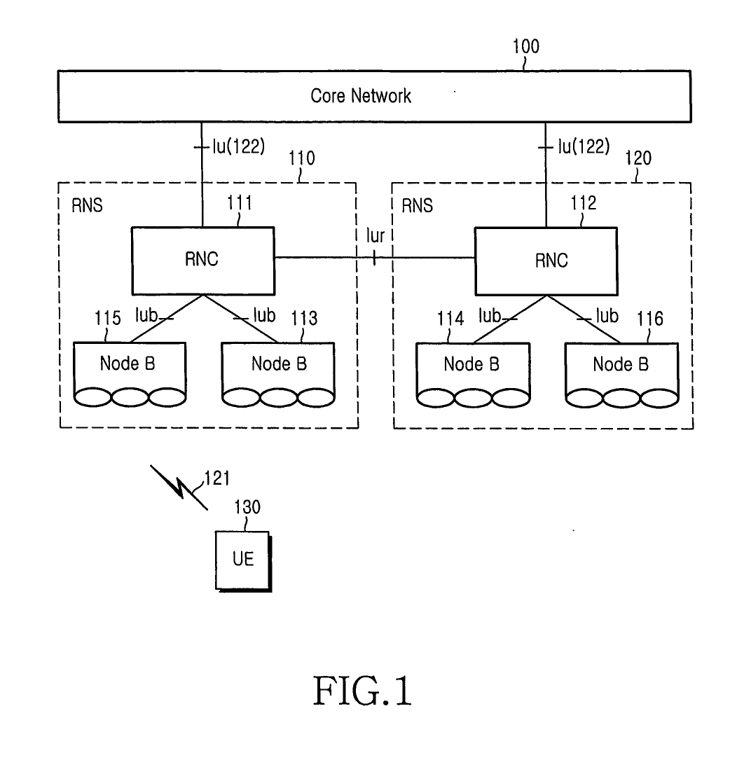

FIG. 2 is a view showing in detail the structure of the conventional Uu interface;

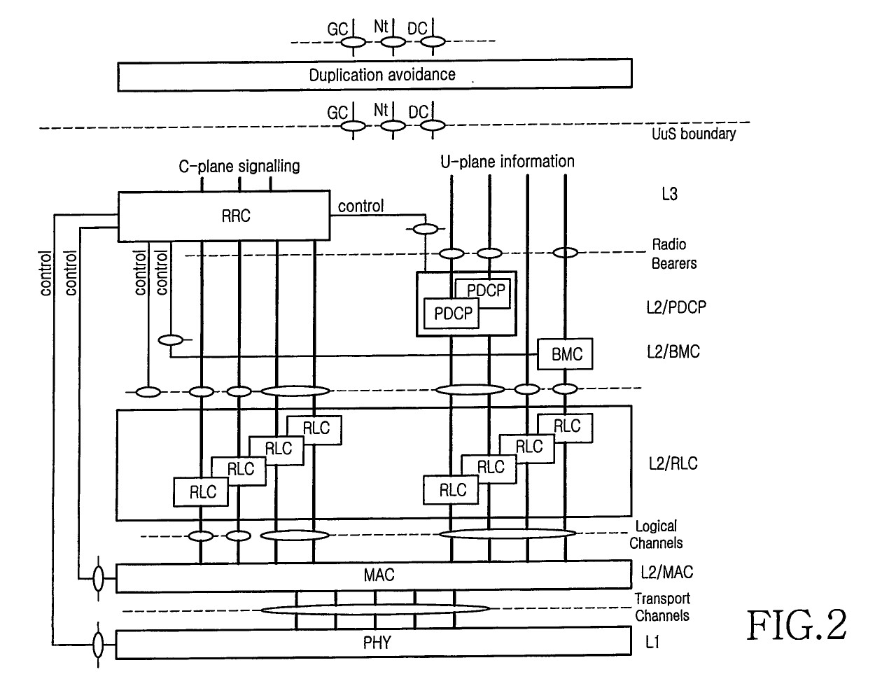

FIG. 3 is a view showing the structure of the conventional MAC-c/sh constituting a RNC;

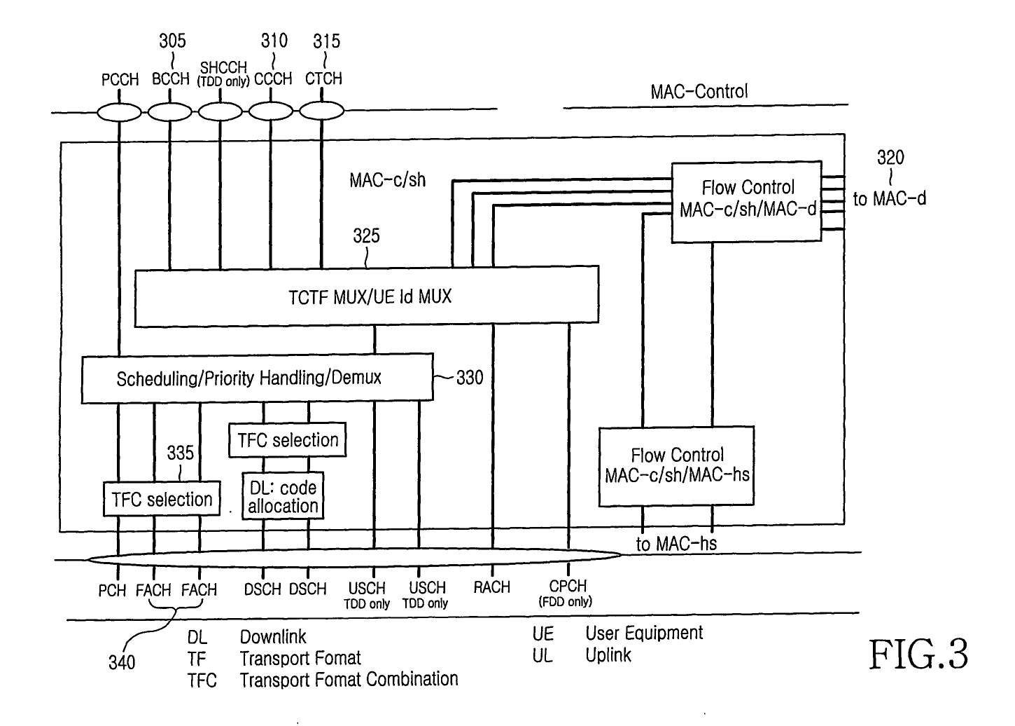

FIG. 4 is a view showing the structure of the conventional MAC-c/sh/m formed in a RNC;

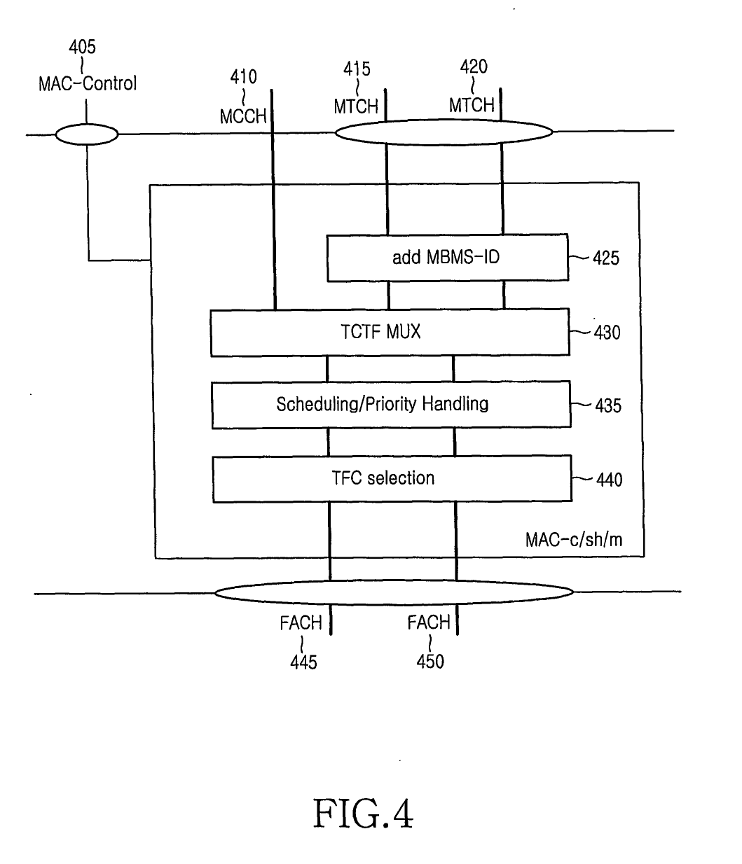

FIG. 5 is a view showing the structure of a MAC PDU of MTCH data when the structure of the MAC-c/sh/m shown in FIG. 4 is used;

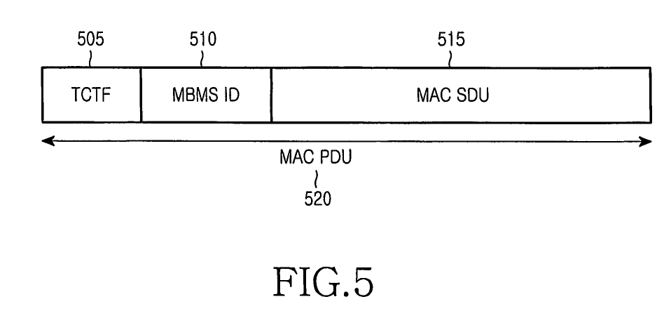

FIG. 6 shows the structure of the conventional MAC-c/sh/m of a UE;

FIGS. 7a to 7c are views MAC PDU structures supported according to each logical channel multiplexing option according to an embodiment of the present invention;

FIG. 8 is a flowdiagram illustrating a control flow by which a RNC determines a MAC header format for a certain MBMS service according to an embodiment of the present invention;

FIG. 9 is a flowdiagram illustrating a control flow by which a UE constructs the processing path of a MTCH by means of MAC configuration information according to an embodiment of the present invention;

FIG. 10 is a view showing the structure of a MAC-c/sh/m in a RNC for constructing a MAC PDU having different MAC header formats according to each logical channel multiplexing option according to an embodiment of the present invention; and

FIG. 11 is a view showing the structure of a MAC-c/sh/m in a UE for receiving a MAC PDU having different MAC header formats according to each logical channel multiplexing option according to an embodiment of the present invention.

### DETAILED DESCRIPTION OF THE PREFERRED EMBODIMENT

Hereinafter, an embodiment of the present invention will be described with reference to the accompanying drawings. In the following detailed description, one representative embodiment of the present invention is proposed to solve the aforementioned technical problems. Further, other embodiments of the present invention are replaced with a description in the configuration of the present invention.

Conventionally, the header of the MAC PDU of a MTCH transmitted through a FACH always includes a TCTF field and a MBMS ID field. However, when only one MTCH, which is a logical channel, is multiplexed to a certain FACH, the header of the MAC PDU does not require the TCTF field. Accordingly, in the present invention, a RNC determines the header format of the MAC PDU and informs UEs of the determined header format. Further, the present invention proposes the structure of a MAC-c/sh/m which enables the TCTF field and the MBMS ID field to be contained in the MAC PDU according to circumstances.

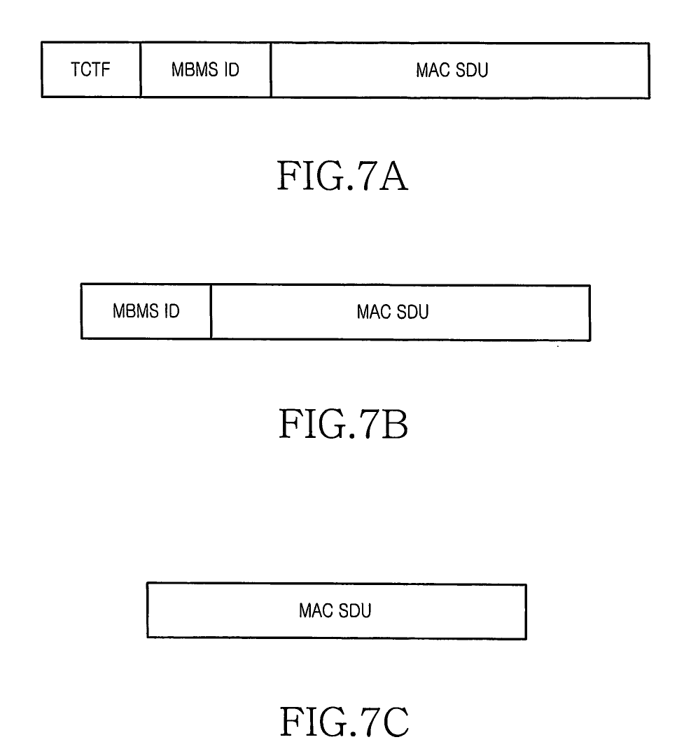

FIGS. 7a to 7c are views MAC PDU structures supported according to each logical channel multiplexing option of a FACH according to an embodiment of the present invention. FIG. 7a shows the structure of the MAC PDU for supporting a first logical channel multiplexing option, FIG. 7b shows the structure of the MAC PDU for supporting a second logical channel multiplexing option, and FIG. 7c shows the structure of the MAC PDU for supporting a third logical channel multiplexing option.

Referring to FIG. 7a, the first logical channel multiplexing option is identical to the conventional logical channel multiplexing option. That is, the MAC PDU requires the TCTF field for distinguishing logical channels transmitted through the same FACHs from each other and the MBMS ID field for distinguishing multiple MTCHs transmitted through the same FACHs from each other. In an embodiment of the present invention, the first logical channel multiplexing option may be appropriately used when a small quantity of data are transmitted in non-real-time. The first logical channel multiplexing option has the biggest advantage in that a FACH may be transmitted through the conventional logical channel multiplexing option. In order to provide the small quantity of data in non-real-time, newly setting a logical channel and a transport channel may be inefficient. Accordingly, it may be efficient to provide the small quantity of data through the logical channel and the transport channel, which are already known, by means of the conventional FACH. Herein, the use of the conventional FACH restrictively has a negative influence on_UEs which does not receive an MBMS service.

Referring to FIG. 7b, since the second logical channel multiplexing option is used when multiple MTCHs are multiplexed to one FACH, it is unnecessary to indicate the kind of logical channel by means of the TCTF field. However, the MBMS ID field must be contained in the MAC PDU in order to distinguish the MTCHs from each other.

Referring to FIG. 7c, since the third logical channel multiplexing option is used when only one MTCH is multiplexed to one FACH, both the TCTF field and the MBMS ID field are not necessary.

The second and the third logical channel multiplexing option may be used when transmission speed for the MBMS service is high, that is, a large quantity of data must be transmitted. The second logical channel multiplexing option may be used when two or more MBMS services are provided in one cell and the MBMS services are provided through one FACH. The third logical channel multiplexing option may be used when transmission speed is very high in multiplexing multiple MTCHs to one FACH.

As described above, in an embodiment of the present invention, since the MAC PDU having different structures is used according to each logical channel multiplexing option, it is necessary to determine a logical channel multiplexing option to be used according to each MTCH and notify a reception side of the determined logical channel multiplexing option. The determination of the logical channel multiplexing option according to each MTCH is performed by a RNC. The RNC determines the multiplexing option according to the radio resource situation of a cell to which the MTCH is to be transmitted and the character of data to be transmitted through the MTCH. Generally, in the case of real-time data, the second and the third logical channel multiplexing option are proper. As the transmission speed increases, the third logical channel multiplexing option is preferred to the second logical channel multiplexing option. The MAC header format according to the determined logical channel multiplexing option must be known to UEs intended for reception of a corresponding MTCH. The UEs must construct a MAC-c/sh/m which processes the MTCH according to the MAC header format.

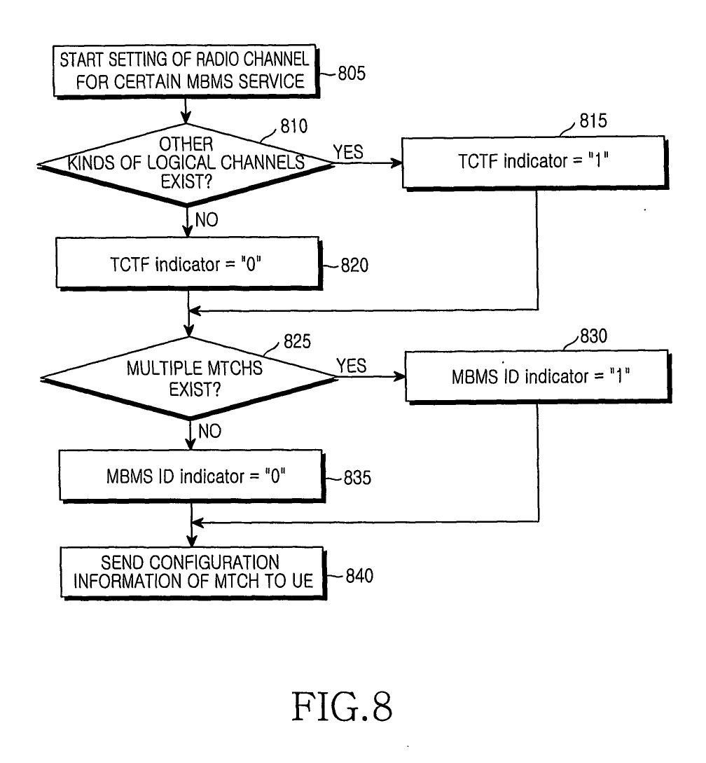

FIG. 8 is a flowdiagram illustrating an operation by which a RNC determines a MAC header format for a certain MBMS service according to an embodiment of the present invention.

The RNC sets a radio channel for providing a certain MBMS service at step 805. The RNC receives quality of service (QoS) required in an MBMS service from a core network and thus the setting of the radio channel may start. The radio channel providing the certain MBMS service includes a MTCH, which is a logical channel, a FACH corresponding to the MTCH, a physical channel transmitting the FACH on an actual radio channel, etc. Accordingly, in step 805, parameters corresponding to the logical channel, a transport channel and the physical channel are determined.

Steps 810, 815, 820, 825, 830 and 835 are processes setting a TCTF identity and a MBMS ID identity which are parameters representing the MAC header format of a MTCH corresponding to the certain MBMS service. The TCTF identity and the MBMS ID identity are set according to each MTCH. In the following description, it is assumed that at least one MTCH for providing the MBMS service through a FACH exists. When the MBMS service is not provided, the conventional operation may be applied.

In step 810, the RNC inspects whether or not other kinds of logical channels except for the MTCH are multiplexed to the transport channel (i.e., FACH). As a result of the inspection, when other kinds of logical channels are multiplexed, step 815 is performed. In contrast, when other kinds of logical channels are not multiplexed, step 820 is performed.

In step 815, the RNC sets the TCTF identity to have a value of 1. In step 820, the RNC sets the TCTF identity to have a value of 0. The setting the TCTF identity to have a value of 1 signifies that a TCTF field exists in the header information of a MAC PDU. In contrast, the setting the TCTF identity to have a value of 0 signifies that the TCTF field does not exist in the header information of the MAC PDU. That is, the TCTF identity is a parameter representing whether or not the TCTF field is contained in the MAC header of the MTCH. In this way, the RNC sets the TCTF identity in steps 810 or 815. Then, step 825 is performed.

In step 825, the RNC determines whether or not multiple MTCHs are multiplexed to the transport channel (i.e., FACH). As a result of the determination, when the multiple MTCHs are multiplexed to one transport channel, step 830 is performed. That is, the RNC sets the MBMS ID identity to have a value of 1. In contrast, when only one MTCH is multiplexed to one transport channel, step 835 is performed. That is, the RNC sets the MBMS ID identity to have a value of 0. The setting the MBMS ID identity to have a value of 1 signifies that a MBMS ID field exists in the header information of the MAC PDU. In contrast, the setting the MBMS ID identity to have a value of 0 signifies that a MBMS ID field does not exist in the header information of the MAC PDU. That is, the MBMS ID identity is a parameter representing whether or not the MBMS ID field is contained in the MAC header of the MTCH. In this way, the RNC sets the MBMS ID identity in steps 830 or 835. Then, step 840 is performed.

In step 840, the RNC includes the set TCTF identity and MBMS ID identity into the configuration information of the MTCH and transmits the configuration information of the MTCH to UEs intended for reception of the corresponding MBMS service. Herein, the RNC may transmit the radio bearer parameter, the transport channel parameter, etc., determined in step 805. The information may be transmitted through a MCCH. The MCCH is a logical channel providing MBMS-related control messages to the UEs intended for reception of the MBMS service and is transmitted through a common channel such as a FACH and a S-CCPCH.

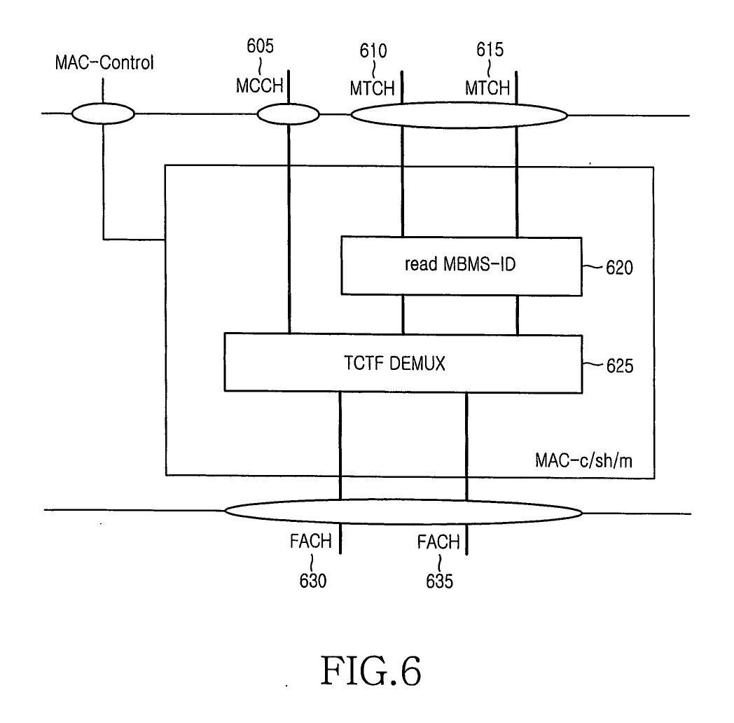

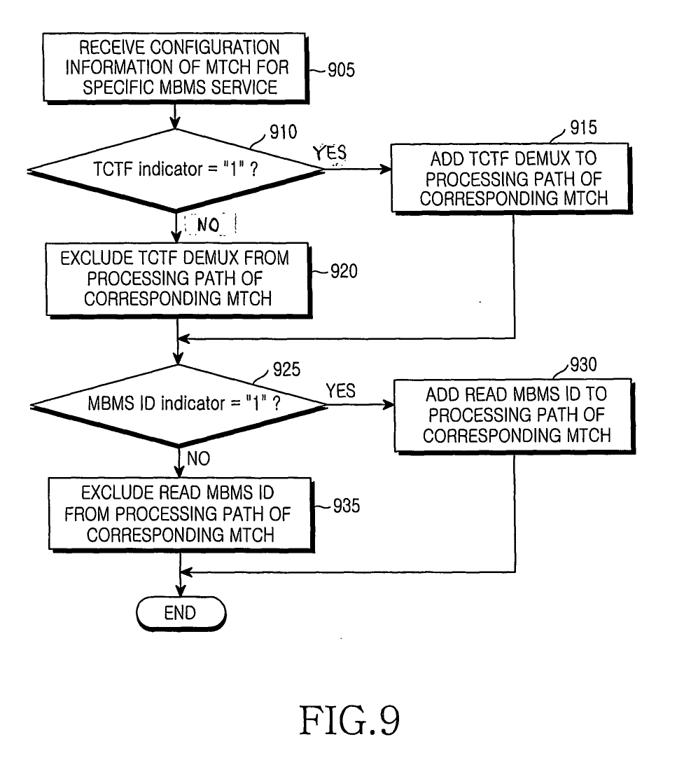

FIG. 9 is a flowdiagram illustrating a control flow by which a UE constructs the processing path of a MTCH by means of the configuration information of the MTCH according to an embodiment of the present invention. Herein, the processing path represents a set of function blocks which a certain logical channel passes through in a MAC layer. For instance, in the conventional structure as shown in FIG. 6, the processing path of all MTCHs is constructed by the TCTF DEMUX and the read MBMS ID.

Referring to FIG. 9, in step 905, the UE obtains the radio channel information of an MBMS service, which the UE is to receive. The radio channel information may be contained in a control message transmitted through a MCCH. Further, the configuration information of the MTCH for the MBMS service is also contained in the radio channel information.

In step 910, the UE having received the configuration information of the MTCH inspects a TCTF identity. As a result of the inspection, when the TCTF identity has been set to have a value of 1, step 915 is performed. That is, the RNC adds a ‘TCTF DEMUX’ to the processing path. In contrast, when the TCTF identity has been set to have a value of 0, the RNC does not add the ‘TCTF DEMUX’ to the processing path. Since the TCTF identity having been set to have a value of 1 signifies that a TCTF field exists in the MAC header of a corresponding MTCH, the TCTF DEMUX may be contained in the processing path to analyze a TCTF field value. In contrast, since the TCTF identity having been set to have a value of 0 signifies that the TCTF field does not exist in the MAC header of the corresponding MTCH, the TCTF DEMUX is not contained in the processing path.

Next, in step 925, the UE inspects a MBMS ID identity constituting the configuration information of the MTCH. As a result of the inspection, when the MBMS ID identity has been set to have a value of 1, step 930 is performed. That is, the RNC adds a ‘read MBMS ID’ to the processing path. In contrast, when the MBMS ID identity has been set to have a value of 0, the RNC does not add the ‘read MBMS ID’ to the processing path. Since the MBMS ID identity having been set to have a value of 1 signifies that a MBMS ID field exists in the MAC header of the corresponding MTCH, the read MBMS ID may be contained in the processing path to analyze a MBMS ID field value. In contrast, since the MBMS ID identity having been set to have a value of 0 signifies that the MBMS ID field does not exist in the MAC header of the corresponding MTCH, it is unnecessary to include the read MBMS ID into the processing path.

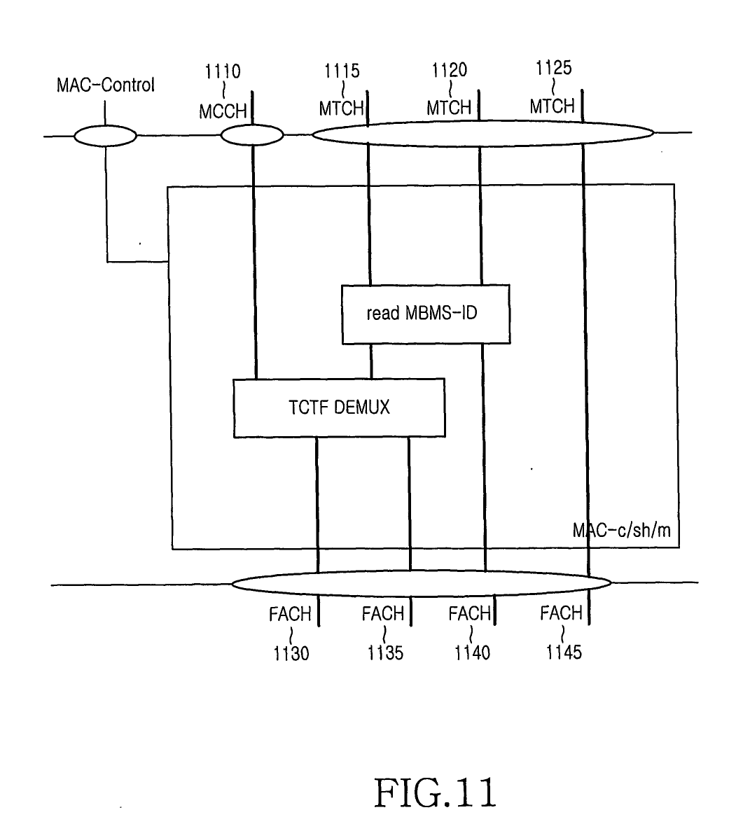

When the setting of the processing path is completed by the aforementioned procedure, the RNC ends the operation according to an embodiment of the present invention in step 940. The processing path for which the setting has been completed will be described with reference to FIG. 11 later.

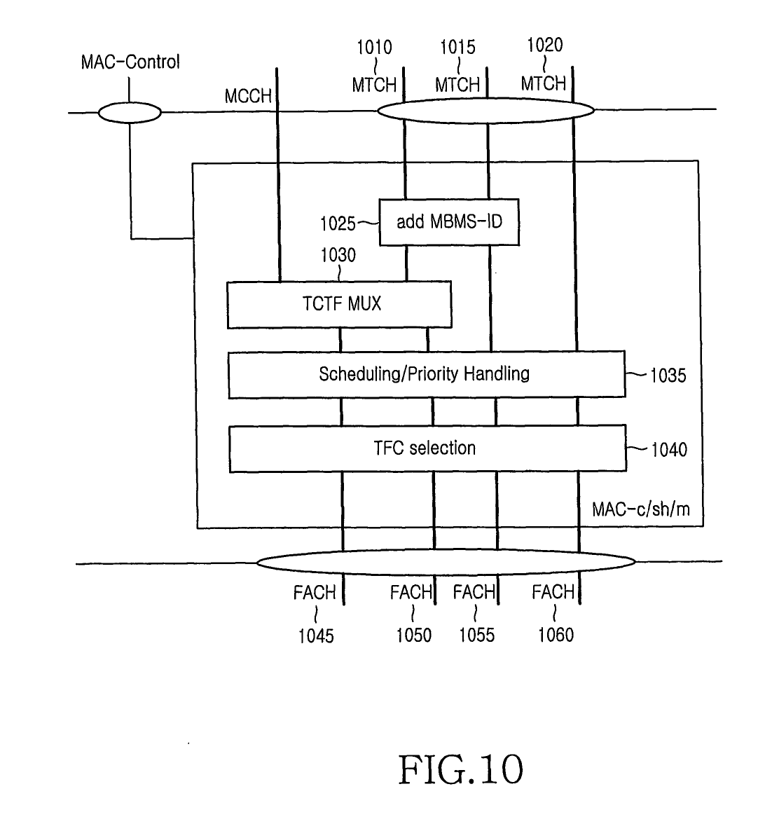

FIG. 10 is a view showing the structure of a MAC-c/sh/m in a RNC for constructing a MAC PDU having different MAC header formats according to each logical channel multiplexing option according to an embodiment of the present invention.

Similarly to the conventional structure, a MCCH is transmitted to a FACH via a TCTF MUX 1030, a scheduling/priority handling 1035 and a TFC selection 1040. When multiple FACHs are formed, a FACH to which the MCCH is to be transmitted (i.e., corresponding relation of the MCCH to the FACH) is determined while the MCCH is initially formed. Further, since an add MBMS ID 1025, a TCTF MUX 1030, a scheduling/priority handling 1035 and a TFC selection 1040, which are function blocks, have the same roles as those of the conventional function blocks, a detailed description is omitted here.

A first MTCH 1010 transmitted by the first logical channel multiplexing option corresponds to a corresponding FACH via the add MBMS ID 1025, the TCTF MUX 1030, the scheduling/priority handling 1035 and the TFC selection 1040. A second MTCH 1015 transmitted by the second logical channel multiplexing option corresponds to a corresponding FACH via the add MBMS ID 1025, the scheduling/priority handling 1035 and the TFC selection 1040. A third MTCH 1020 transmitted by the third logical channel multiplexing option corresponds to a corresponding FACH via the scheduling/priority handling 1035 and the TFC selection 1040. Accordingly, the first MTCH 1010 supports the MAC header format in FIG. 7a, the second MTCH 1015 supports the MAC header format in FIG. 7b, and the third MTCH 1020 supports the MAC header format in FIG. 7c.

The FACHs 1045, 1050, 1055 and 1060 shown in FIG. 10 represent FACHs formed in one cell and corresponding relations between the MTCHs and the FACHs is determined while a corresponding MTCH is formed. The FACHs may also be the conventional FACHs, configuration information of which is known to all UEs in a cell. Further, the FACHs may be new FACHs, configuration information of which is known to only UEs intended for reception of the configuration information.

FIG. 11 is a view showing the structure of a MAC-c/sh/m in a UE for receiving a MAC PDU having different MAC header formats according to each logical channel multiplexing option according to an embodiment of the present invention.

Referring to FIG. 11, a UE receives the configuration information of a MTCH from a RNC through a MCCH and extracts a TCTF identity and a MBMS ID identity from the configuration information of the MTCH. Then, the UE determines the processing path of a specific MTCH by means of the TCTF identity and the MBMS ID identity. For instance, when receiving the configuration information of the MTCH in which the TCTF identity and the MBMS ID identity have been set to have a value of 1, the UE sets a processing path passing through both a read MBMS ID and a TCTF DEMUX as a first MTCH 1115. When receiving the configuration information of the MTCH in which the TCTF identity have been set to have a value of 0 and the MBMS ID identity have been set to have a value of 1, the UE sets a processing path passing through only the read MBMS ID as a second MTCH 1120. Finally, when receiving the configuration information of the MTCH in which the TCTF identity and the MBMS ID identity have been set to have a value of 0, the UE sets a processing path which does not pass through the read MBMS ID and the TCTF DEMUX as a third MTCH 1125.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

As can be seen from the foregoing, according to the present invention, an MBMS service is transmitted or received through different processing paths according to each logical channel multiplexing option, so that the MBMS service can be more efficiently provided. Further, unnecessary information is prevented from being transmitted, so that radio resources can be saved.

What is claimed is:

1. A method for generating a frame transmitting broadcasting data in a radio network controller of a mobile communication system transmitting logical channels, which include a broadcasting service transport channel transmitting the broadcasting data according to a broadcasting service and a broadcasting service control channel transmitting control information according to the broadcasting service, to one or more user equipments located in each cell through a transport channel, the method comprising the steps of:
determining at least one logical channel to be transmitted through one transport channel; and
generating a frame which does not contain a target channel type field (TCTF) and a MBMS ID field, but contains a payload for transmitting the broadcasting data, when one broadcasting service transport channel is determined as the logical channel.

2. The method according to claim 1, further comprising a step of generating a frame containing the MBMS ID field and the payload for transmitting the broadcasting data, when multiple broadcasting service transport channels are determined as the logical channel.

3. The method according to claim 1 or 2, further comprising a step of generating a frame containing the target channel type field, the MBMS ID field, and the payload for transmitting the broadcasting data, when one or more broadcasting service transport channels and other logical channels are determined as the logical channel.

4. The method according to claim 3, further comprising a step of, before transmitting the frame, transmitting a target channel type field identity and a MBMS ID identity, which represents whether or not the target channel type field and the MBMS ID field are contained in the frame, to the user equipment through the broadcasting service control channel.

5. A method for receiving a frame including broadcasting data from a radio network controller in a user equipment of a mobile communication system receiving logical channels, which include a broadcasting service transport channel transmitting the broadcasting data according to a broadcasting service and a broadcasting service control channel transmitting control information according to the broadcasting service, through a transport channel, the method comprising the steps of:
confirming a logical channel multiplexing option used in the frame through the broadcasting service control channel;
setting a processing path of the frame by the logical channel multiplexing option; and
processing the frame through the set processing path.

6. The method according to claim 5, wherein, when it is confirmed that the logical channel multiplexing option is a logical channel multiplexing option transmitting only one broadcasting service transport channel through one transport channel, a function block for processing a target channel type field and a MBMS ID field is excluded from the processing path.

7. The method according to claim 5 or 6, wherein, when it is confirmed that the logical channel multiplexing option is a logical channel multiplexing option transmitting multiple broadcasting service transport channels through one transport channel, a function block for processing a MBMS ID field constituting the message is contained in the processing path.

8. The method according to claim 7, wherein, when it is confirmed that the logical channel multiplexing option is a logical channel multiplexing option transmitting at least one broadcasting service transport channel and other logical channels through one transport channel, a function block for processing a target channel type field and a MBMS ID field constituting the message is contained in the processing path.

9. A method for generating a frame transmitting broadcasting data in a radio network controller of a mobile communication system transmitting logical channels, which include a broadcasting service transport channel transmitting the broadcasting data according to a broadcasting service and a broadcasting service control channel transmitting control information according to the broadcasting service, to one or more user equipments located in each cell through a transport channel, the method comprising the steps of:
determining at least one logical channel to be transmitted through one transport channel; and
generating a frame containing a MBMS ID field and a payload transmitting the broadcasting data, when multiple broadcasting service transport channels are determined as the logical channel.

10. The method according to claim 9, further comprising a step of, before transmitting the frame, transmitting a MBMS ID identity, which represents whether or not a MBMS ID field is contained in the frame, to the user equipment through the broadcasting service control channel.

11. A method for receiving a frame including broadcasting data from a radio network controller in a user equipment of a mobile communication system receiving logical channels, which include a broadcasting service transport channel transmitting the broadcasting data according to a broadcasting service and a broadcasting service control channel transmitting control information according to the broadcasting service, through a transport channel, the method comprising the steps of:
confirming a logical channel multiplexing option used in the frame through the broadcasting service control channel;
setting a processing path excluding function blocks for processing a target channel type field and a MBMS ID field, when it is confirmed that the logical channel multiplexing option is a logical channel multiplexing option transmitting only one broadcasting service transport channel through one transport channel;
setting a processing path so that the function block for processing the target channel type field is excluded and the function block for processing the MBMS ID field is contained, when it is confirmed that the logical channel multiplexing option is a logical channel multiplexing option transmitting multiple broadcasting service transport channels through one transport channel;
setting a processing path so that the function blocks for processing the target channel type field and the MBMS ID field are contained, when it is confirmed that the logical channel multiplexing option is a logical channel multiplexing option transmitting at least one broadcasting service transport channel and other logical channels through one transport channel; and
processing the frame through the set processing paths.

12. A method for generating a frame transmitting broadcasting data in a radio network controller of a mobile communication system transmitting logical channels, which include a broadcasting service transport channel transmitting the broadcasting data according to a broadcasting service and a broadcasting service control channel transmitting control information according to the broadcasting service, to one or more user equipments located in each cell through a transport channel, the method comprising the steps of:
determining at least one logical channel to be transmitted through one transport channel;
generating a payload for transmitting the broadcasting data, when one broadcasting service transport channel is determined as the logical channel;
generating a frame containing a MBMS ID field and a payload transmitting the broadcasting data, when multiple broadcasting service transport channels are determined as the logical channel; and
generating a frame containing the target channel type field, the MBMS ID field, and the payload for transmitting the broadcasting data, when one or more broadcasting service transport channels and other logical channels are determined as the logical channel.

13. The method according to claim 12, further comprising a step of, before transmitting the frame, transmitting a target channel type field identity and a MBMS ID identity, which represents whether or not the target channel type field and the MBMS ID field are contained in the frame, to the user equipment through the broadcasting service control channel.
